(19) United States
(12) Patent Application Publication
(10) Pub. No.: US 2012/0249054 A1
(43) Pub. Date: Oct. 4, 2012

(54) UNIVERSAL CHARGING BOARD ASSEMBLY AND METHOD FOR PROVIDING POWER TO DEVICES CONNECTED THEREOF

(76) Inventors: Paul King, New York, NY (US); David Walke, New York, NY (US)

(21) Appl. No.: 13/074,088

(22) Filed: Mar. 29, 2011

(51) Int. Cl. H02J 7/00

(52) U.S. Cl. 320/107

(57) ABSTRACT

A multi-device charging assembly for providing electrical power includes a power control assembly configured for supplying a plurality of charging voltages to at least one electronic device, a display board assembly configured for displaying status information to a user associated with the at least one electronic device, and a microcontroller board assembly configured for controlling each of the power control assembly and the display board assembly. The microcontroller board assembly determines whether at least one charging port is connected to the at least one electronic device, and determines whether payment is received from the user for supplying a charging voltage to the at least one electronic device. The microcontroller board assembly transmits information to the power control assembly for supplying the charging voltage to the at least one charging port upon receiving the payment.

### FIELD OF THE INVENTION

This invention relates to the field of battery charging technology. More specifically, the present invention relates to a universal battery recharging board that provides for recharging different types of rechargeable batteries of a variety of portable devices.

### BACKGROUND OF THE INVENTION

The proliferation of portable electronic devices has increased substantially through the years as today's technology-savvy generation has accumulated numerous portable electronic devices, from laptop computers, cell phones, and personal digital assistants, to digital cameras, portable DVD players, and the like. For each of these electronic devices, either a replacement battery is needed, which can be very costly, or a way to recharge the current depleted battery. Examples of rechargeable batteries include nickel-cadmium (NiCad), nickel-hydrogen (NiH₂), nickel-metal hydride (NiMH), lithium ion (Li-ion), lithium polymer (Li-polymer), and lead acid batteries. Electronic devices, such as cell phones, become disabled or inoperable when the power of the battery drops below a certain threshold. At that time, users of electronic devices must either replace depleted batteries or find a power source to recharge the depleted battery.

In order to recharge the current depleted battery in these electronic devices, a battery charger is necessary. When people are in public venues, they may not have a battery charger with them. Even if they do have a battery charger with them, it is often difficult to find an outlet that one can plug in to. Therefore, providing a public space that provides powered charging cords can be a valuable amenity.

In addition, many electronic devices have different charging cords. As a result, users who own several different portable devices may have to carry numerous chargers with them in order to recharge their phones or devices. In other words, a typical consumer having three different types of portable devices may have three different battery chargers—the consumer may have a first battery charger for his wireless telephone, a second battery charger for his camcorder, and a third battery charger for his Pocket PC. Whether at home, traveling, or in public venues, it may be difficult to have all of these chargers available. Further, it could be difficult to find an outlet for all these devices even if one does have all the chargers accessible.

Thus, there is clearly a need for a charging assembly that may selectively provide a charge to a variety of user portable devices in a public area, as well as be able to determine the device being charged and selectively dispense charges to the portable device through a free charging or fee-based system.

### SUMMARY OF THE INVENTION

An object of the invention is to overcome the drawbacks of previous inventions.

Another object of the invention is to provide a novel and useful portable device charging assembly contained in a fee based charging station.

Another object of the invention is to provide a novel and useful charging assembly that provides control for multiple power circuits for charging at least one portable device.

Another object of the invention is to provide a charging assembly for charging a plurality of battery powered portable devices at the same time through a free-charge or fee based system.

Another object of the invention is to provide a charging assembly for determining whether a portable device is connected to a communication channel.

Another object of the invention is to provide a charging assembly that may be configured to selectively adjust the charging rate and charging time at the board level.

Another object of the invention is to provide a charging assembly that may recognize and deliver the maximum charging current that is needed for charging.

In a first non-limiting embodiment of the invention, a charging board assembly for providing electrical power to one or more electronic devices is provided and includes a power supply assembly adapted for supplying electrical power to the one or more electronic devices; and a microcontroller board assembly for determining whether to turn on electrical power to be delivered to at least one charging port connect to the electronic device.

In a second non-limiting embodiment of the invention, a multi-device charging assembly for providing electrical power includes a power control assembly configured for supplying a plurality of charging voltages to at least one electronic device, a display board assembly configured for displaying status information to a user associated with the at least one electronic device, and a microcontroller board assembly configured for controlling each of the power control assembly and the display board assembly. The microcontroller board assembly determines whether at least one charging port is connected to the at least one electronic device, and determines whether payment is received from the user for supplying a charging voltage to the at least one electronic device. The microcontroller board assembly transmits information to the power control assembly for supplying the charging voltage to the at least one charging port upon receiving the payment.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems and methods for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present principles, reference is now made to the following figures:

FIG. 1 is a diagram illustrating a charging station according to a preferred embodiment of the invention;

FIG. 2 illustrates an example of a block diagram of the circuitry of a charging board assembly used in the charging station according to an embodiment of the invention;

FIG. 3 illustrates an example of a controller board circuitry according to an embodiment of the invention;

FIG. 4 illustrates an example of a power board circuitry according to an embodiment of the invention;

FIG. 5 illustrates an example of a power board circuitry with a communication device according to an embodiment of the invention;

FIG. 6 illustrates an example of a LED board circuitry according to an embodiment of the invention; and

FIG. 7 is a flow chart depicting the method of utilizing the charging station of FIG. 1 according to an embodiment of the invention.

### DETAILED DESCRIPTION OF THE EMBODIMENTS OF THE INVENTION

The invention may be understood more readily by reference to the following detailed description of preferred principles of the invention. However, techniques, systems, and operating structures in accordance with the preferred principles may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the invention. It must be noted that, as used in the specification and the appended claims, the singular forms “a”, “an”, and “the” include plural referents unless the context clearly indicates otherwise. Some elements of the present principles are illustrated as modules for performing described functions. While these modules may be described in terms of software implementations, any hardware, or combination of hardware and software may be used to implement the present principles without deviating from the scope or spirit thereof. Moreover, well known methods and procedures for both carrying out the objectives of the present invention and illustrating the preferred embodiment are incorporated herein but have not been described in detail as not to unnecessarily obscure novel aspects of the present invention.

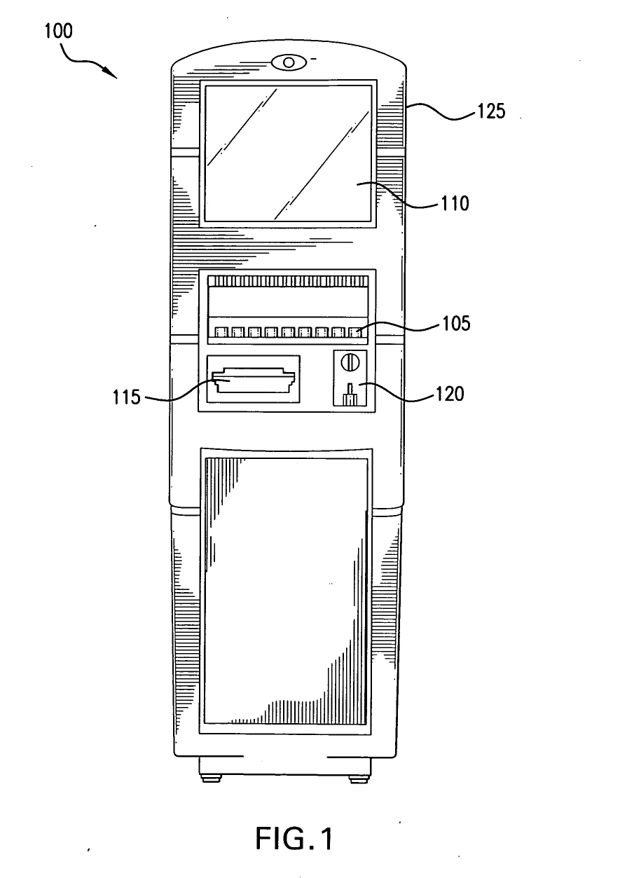

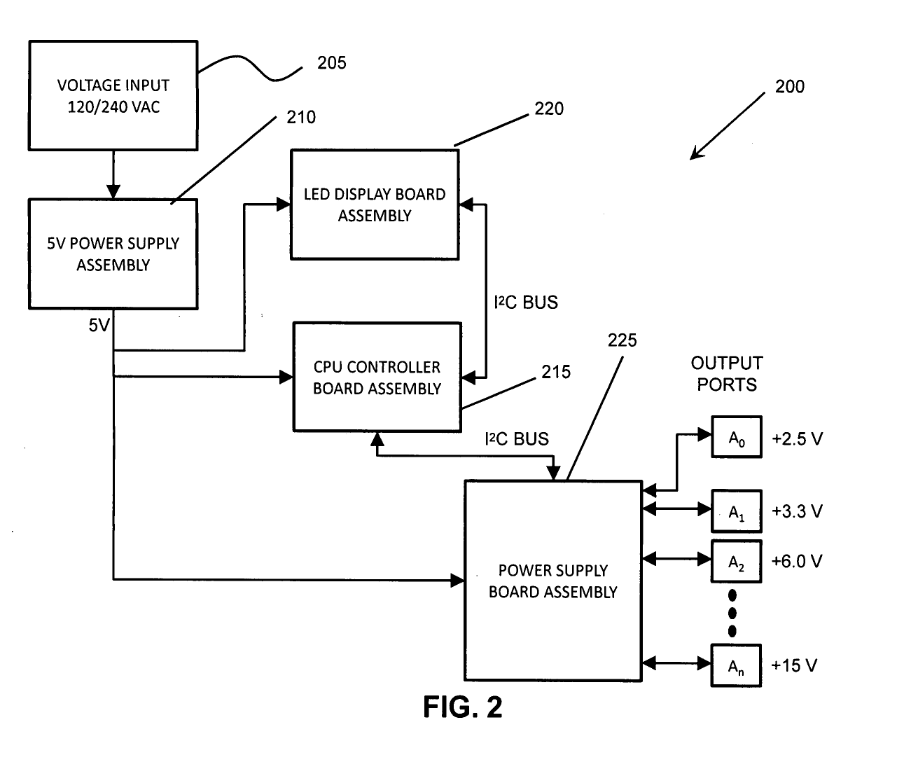

Referring now to FIG. 1, there is shown an automated charging station 100 having a multi-device charging board assembly 200, for which a schematic block diagram is shown in FIG. 2, in order to provide an on-demand charge for a plurality of portable devices according to a preferred embodiment of the invention. Particularly, the board assembly 200 is contained within a housing 125 and interfaces with a user's portable device (not shown) through a plurality of charging connectors such as, for example, charging connector 105 in order to provide an on-demand charge to the portable device. The automated charging station 100 also includes a display monitor 110, for displaying messages related to negotiating payment from a user upon connection to the charging station 100 or provision for displaying any messages during use of the charging station 100. It should be appreciated that the charging station 100 may provide either a free charge or a fee-based charge through negotiation with a user. In one embodiment, a fee is accepted through a bill acceptor slot 115 or a coin acceptor slot 120. Alternatively, a credit or debit-card slot may also be provided (not shown) for receiving payment. The charging assembly 200 may include circuit-board technology capable of passing all UL94-V0 flammability tests and uses surface mount components to facilitate rapid assembly. The charging assembly 200 also includes memory to store the number of charges provided by charging assembly 200, up to a maximum number of 32,000 charges for each audit of the automated charging station 100.

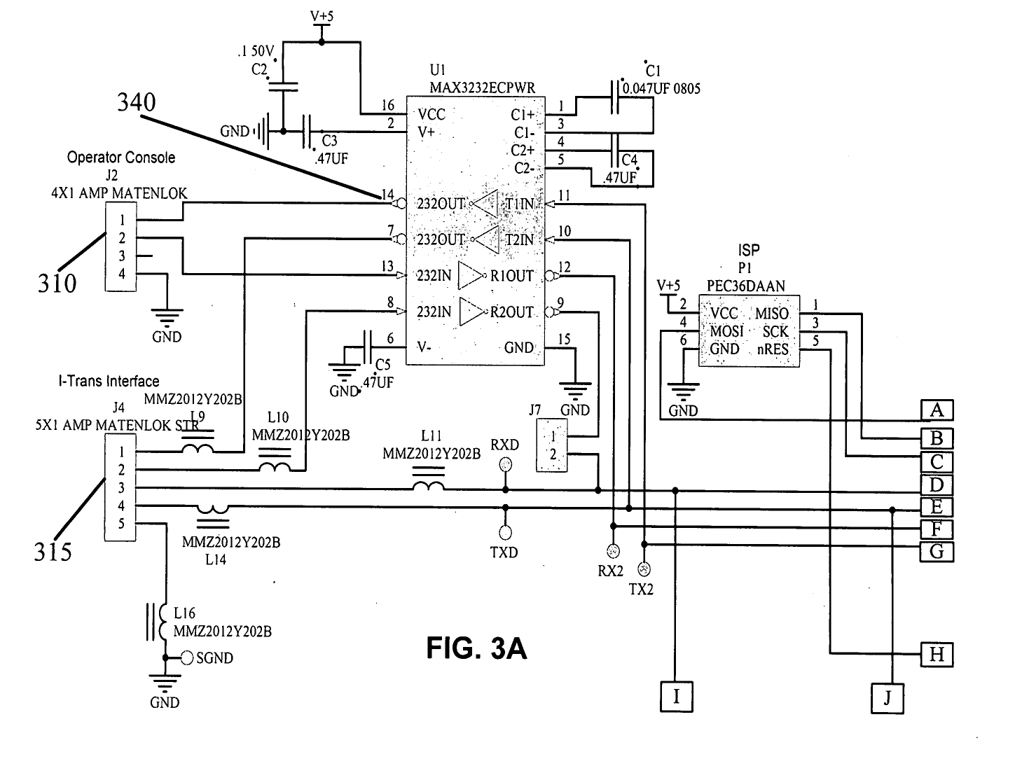

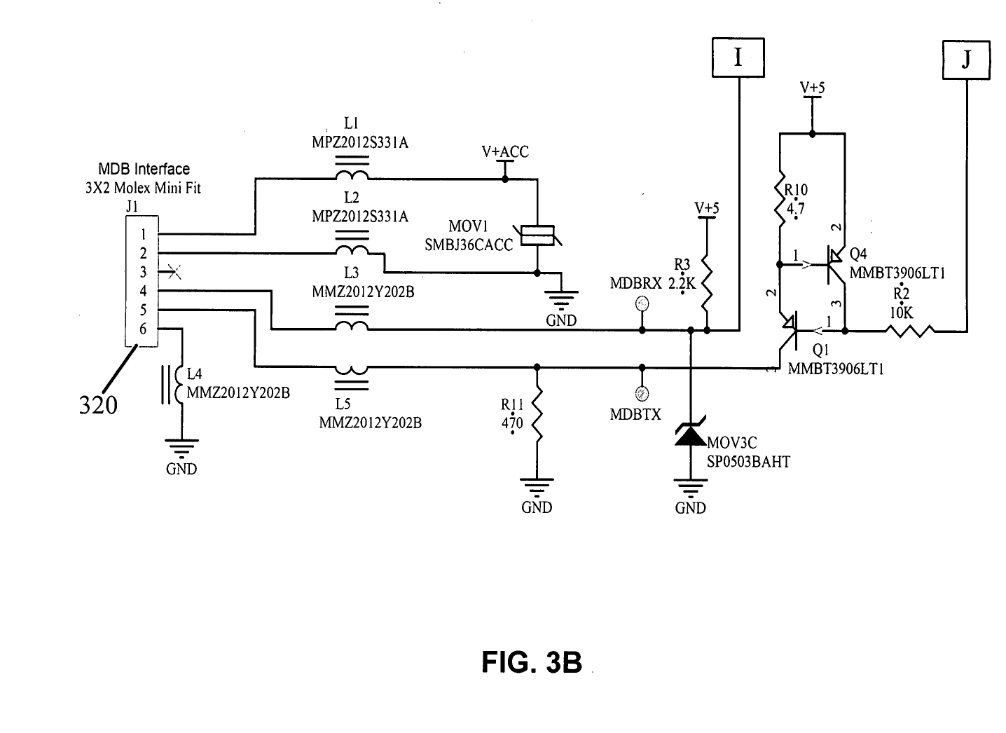

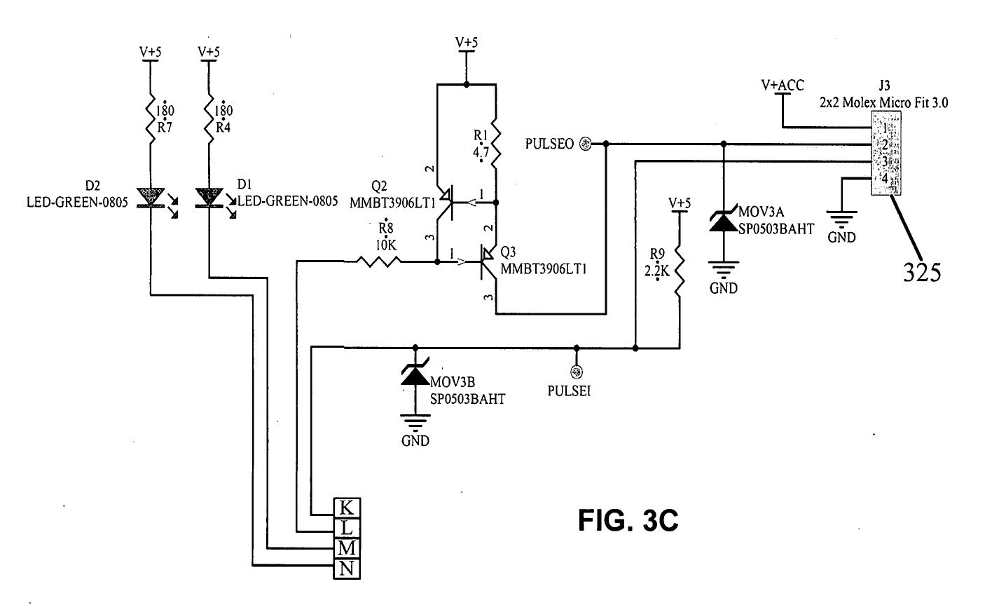

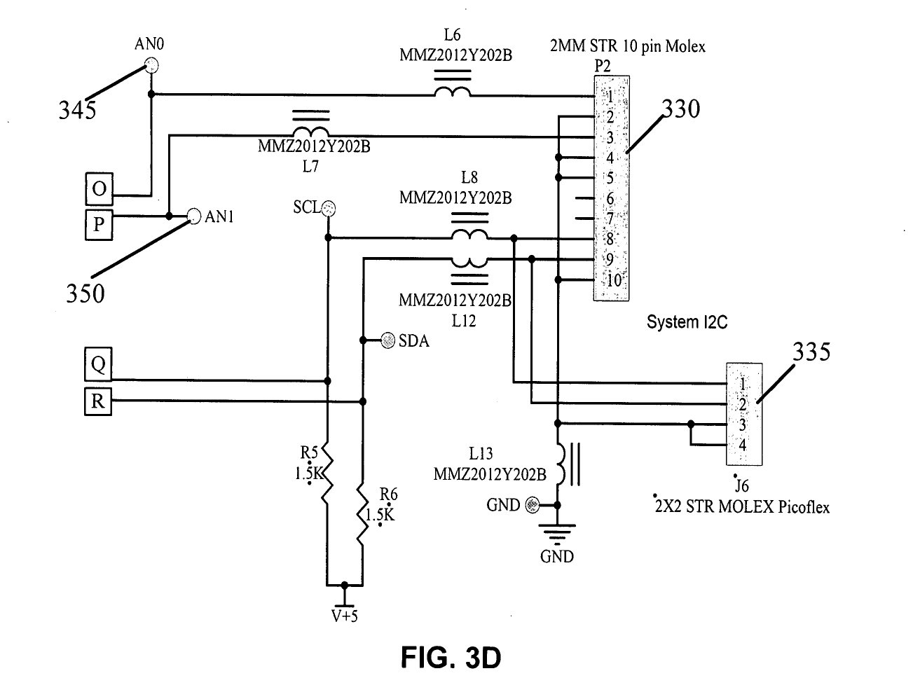

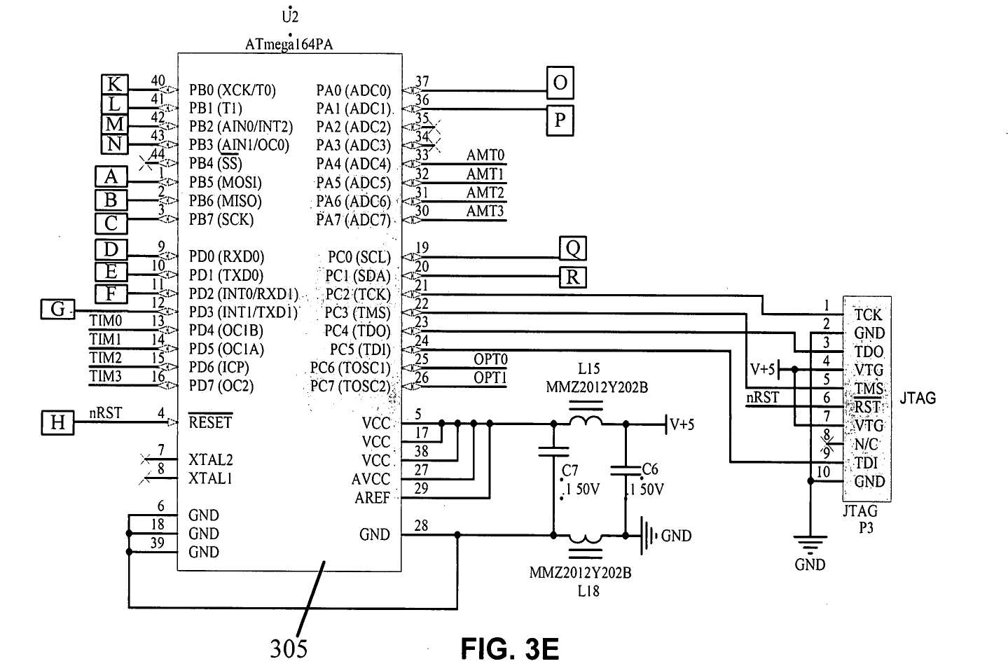

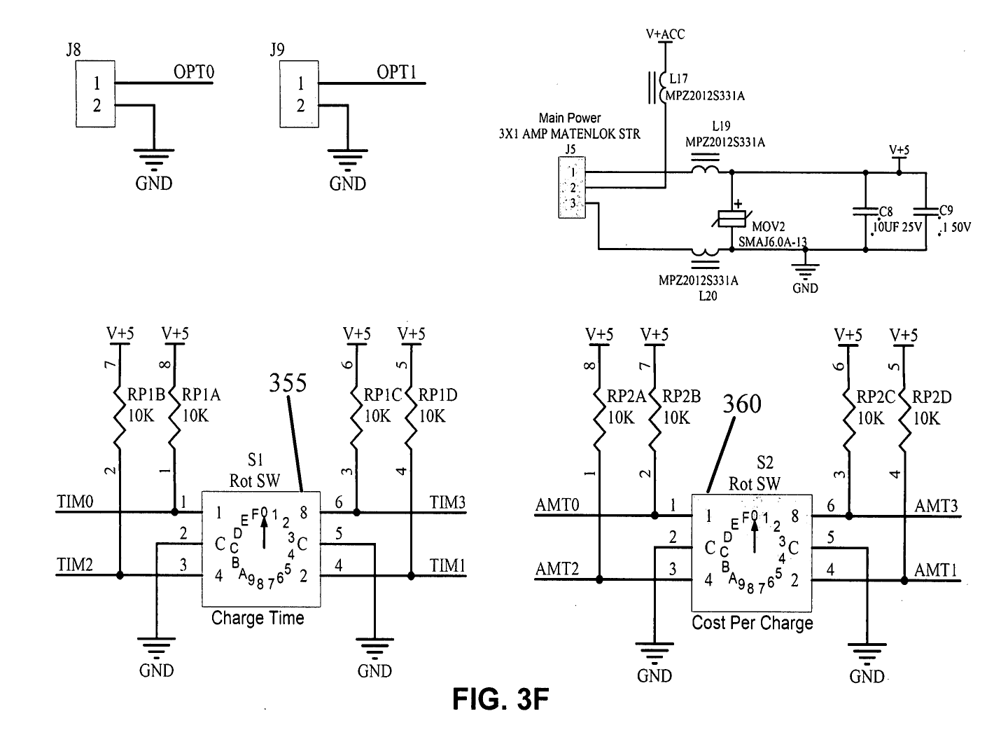

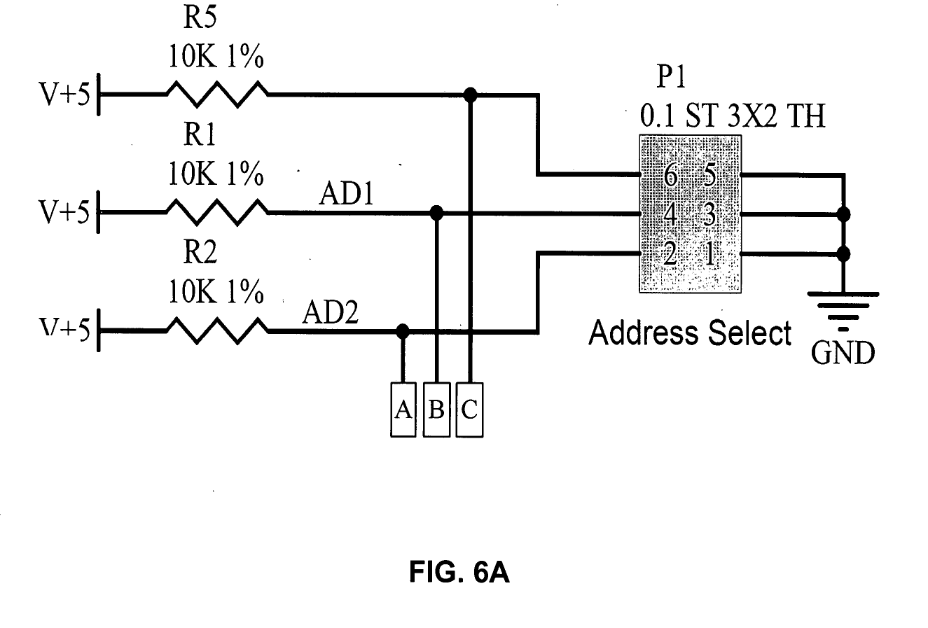

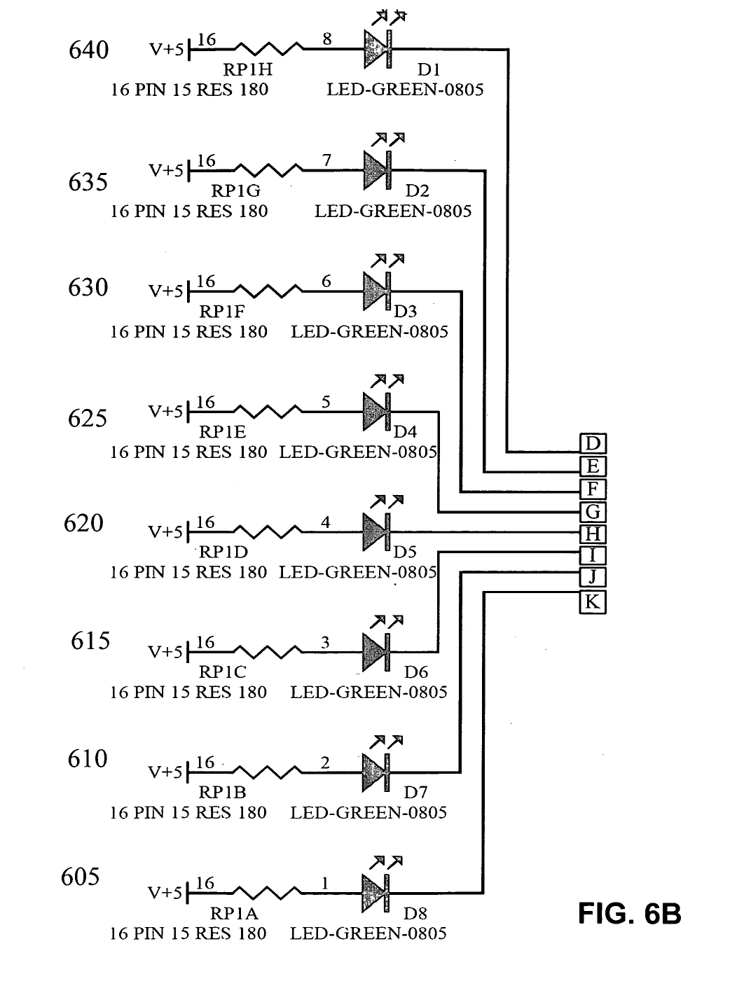

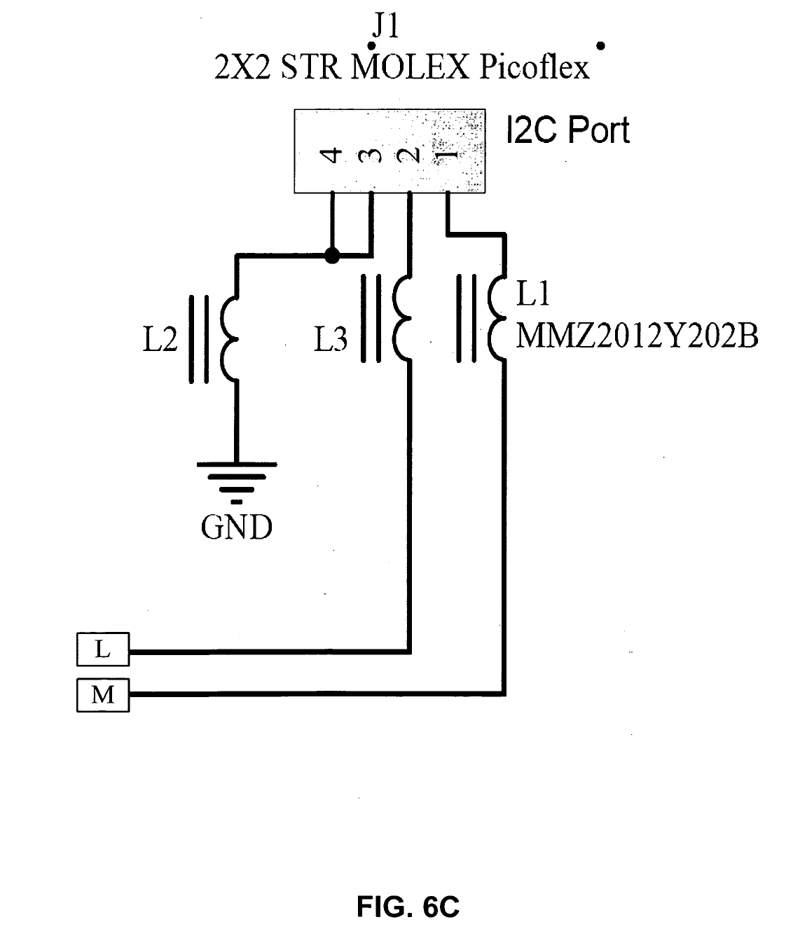

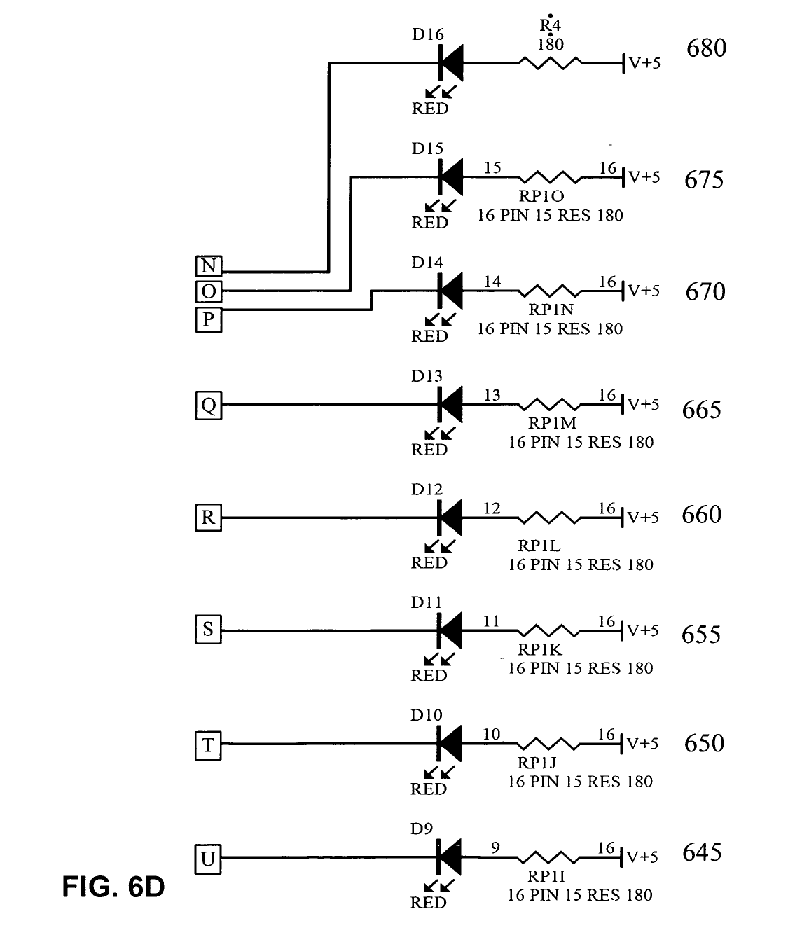

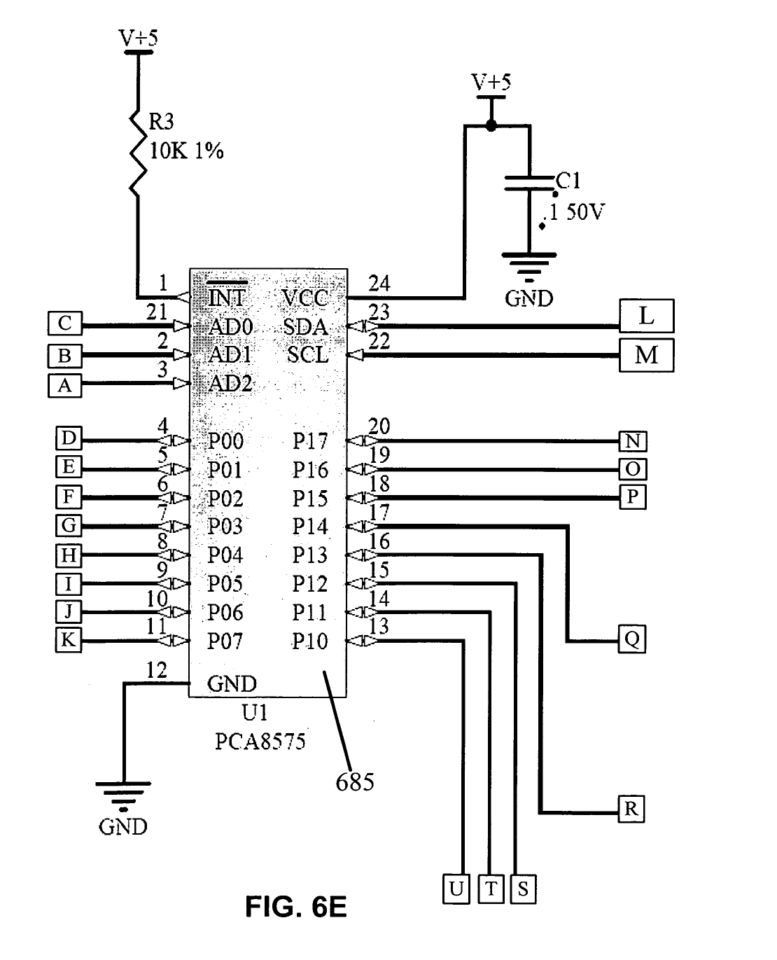

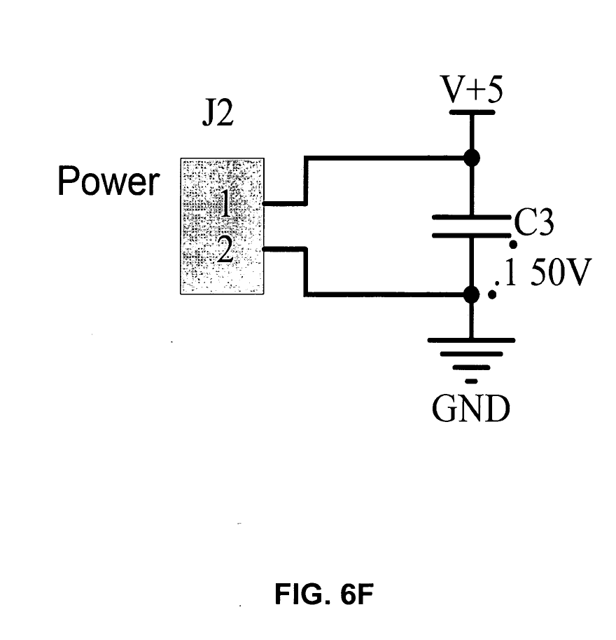

FIG. 2 shows a schematic block diagram of the charging board assembly 200 that is used to provide an on-demand charge to at least one portable device connected to board assembly 200 through the charging connector 105 (FIG. 1). As shown, the board assembly 200 is powered from a 120 volt AC (VAC) source 205 being delivered directly to a standard 5 volt power supply module 210 in order to provide 5 volts DC power to the various modules and boards in the system through an AC-to-DC conversion from 120 VAC to 5 VDC. The power supply module 210 is a standard power supply, preferably the LPT80 Series AC-DC power supply available from Emerson™ is Network Power, although other power supply manufacturers may be utilized without departing from the spirit of the invention. The power supply module 210 provides this 5 volt DC system power to the CPU controller board assembly 215 (“Controller board assembly 215”), the LED board assembly 220, and the power supply board assembly 225 (shown in FIGS. 3-6) as well as being used as a 5 volt DC power source for charging portable devices requiring 5 volts. The CPU controller board assembly 215 is communicatively coupled to the power supply board assembly 225 and the LED display board assembly 220 and controls sourcing voltages supplied to the ends/tips of each charging connector 105 (FIG. 1) at the multiple output connector ports such as, for example, ports A₀-Aₙ. The controller board assembly 215 controls the power supply board assembly 225 and LED display board assembly 220 through an Inter-Integrated Circuit bus (hereinafter “I²C”), which will be shown and described below. In one non-limiting embodiment, the controller board assembly 215 controls three switching power supplies (FIG. 6) on the power supply board assembly 225 and the power supply module 210 through the I²C bus, and these power supplies are configured to selectively supply voltages in the range between 2.5 Volts and 15 Volts for, in one non-limiting embodiment, up to eight communication channels for each power supply board assembly 225, with each communication channel being coupled to a respective connector, provided at connector ports A₀-Aₙ. These connector ports A₀-Aₙ supply the required charging voltages and currents to the portable devices. In other non-limiting embodiments, additional communication channels may be provided (by additional connector ports) through modular power supply board assemblies similar to power supply board assembly 225 that may be connected to board assembly 200 and controlled by the controller board assembly 215. As such, the board assembly 200, being modular, may be expandable via the additional power supply board assemblies for providing additional connector ports with additional charging voltages in the range of 2.5 volts to 15 volts to charge the various user portable devices. It should be appreciated that the board assembly 200 works independently for each portable device connected to the connector ports A₀-Aₙ by supplying the appropriate voltage and maximum currents that any portable device connected will take. The communication channels are independent so that only the channel that has been connected and paid for is energized for charging the portable device to which it is connected. The board assembly monitors the communication channels by scanning each channel periodically to detect whether any portable device is connected to any of the communication channel or port, whether any communication is occurring at any of the other board assemblies, detects whether payments have been made, and monitoring each channel after payment has been received to ensure that only the channel or channels connected to the portable devices are receiving a charge and not the other non-connected ports. It should also be appreciated that connector ports A₀-Aₙ receive a predetermined voltage and maximum current based on the charging cable that is selectively attached to the power supply board 225 (not shown). The microcontroller 305, upon determining that a particular charging cable is connected and authorized to receive a charge, supplies the appropriate voltage and maximum charging current to the output connector A0-An by turning one of the independent power circuits on power supply board assembly 225 to the ON mode for the duration of time that has been purchased by the user. The power supply board 225 is provided to receive any cable, including USB cables of devices, and other portable devices, such as cellular phones, portable computers, MP3 players, CD players, and other similar types of devices.

FIG. 3 illustrates a circuit diagram for CPU controller board assembly 215 according to a preferred embodiment of the invention. As shown, the controller board assembly 215 includes an 8-bit microcontroller 305 for controlling the overall charging operation of charging assembly 200 (FIG. 2). The controller board assembly 215 may preferably utilize an ATMEL® 8-bit microcontroller having a 16 Kbyte Flash ROM 305, together with resistors, capacitors, and other components whose values are shown are illustrated in FIG. 3. In other non-limiting embodiments, any 8-bit microcontroller may be utilized without departing from the scope of the invention. The controller board assembly 215 includes two serial communication interfaces 310, 315 for interfacing with respective serial communication devices. Particularly, 4-pin connector 310 is provided to interface with an operator terminal in order to determine audit information, such as charges provided by charging station 100 (FIG. 1), or to determine audit information regarding billing rate and charge times that have been provided by charging assembly 200. This function is performed through a RS-232 transceiver 340, for example, a Maxim® MAX3232 RS-232 transceiver, which is configured to communicate the audit information. Also, 5-pin connector 315 is provided to interface with bill acceptor 115 and coin acceptor 120 to process payments received in this manner. Further, a 6-pin multi-drop bus connector 320 is provided to connect to a multi-drop bus serial device such as a credit-card acceptor, a debit card acceptor, or other similar type of payment device. A 4-pin connector 325 is configured to operate with a relay to control the coin acceptors or the credit card acceptors.

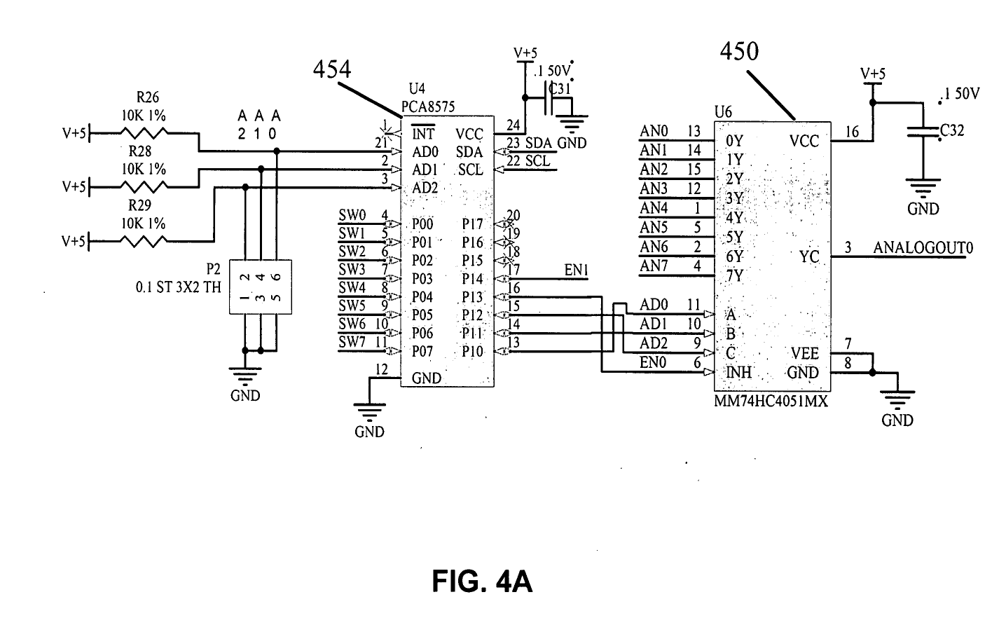

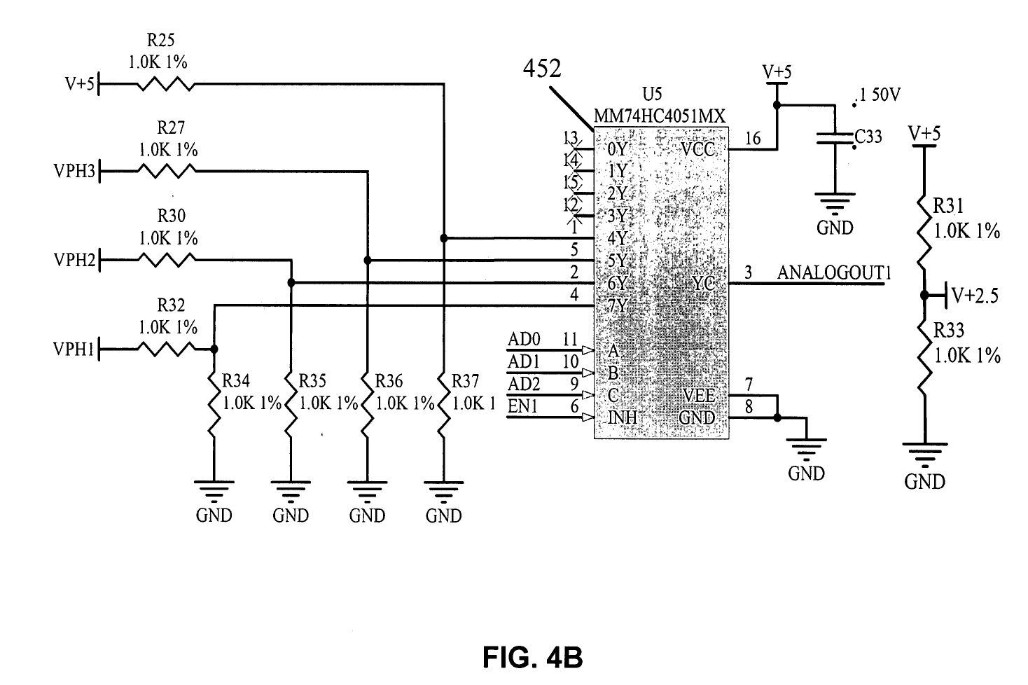

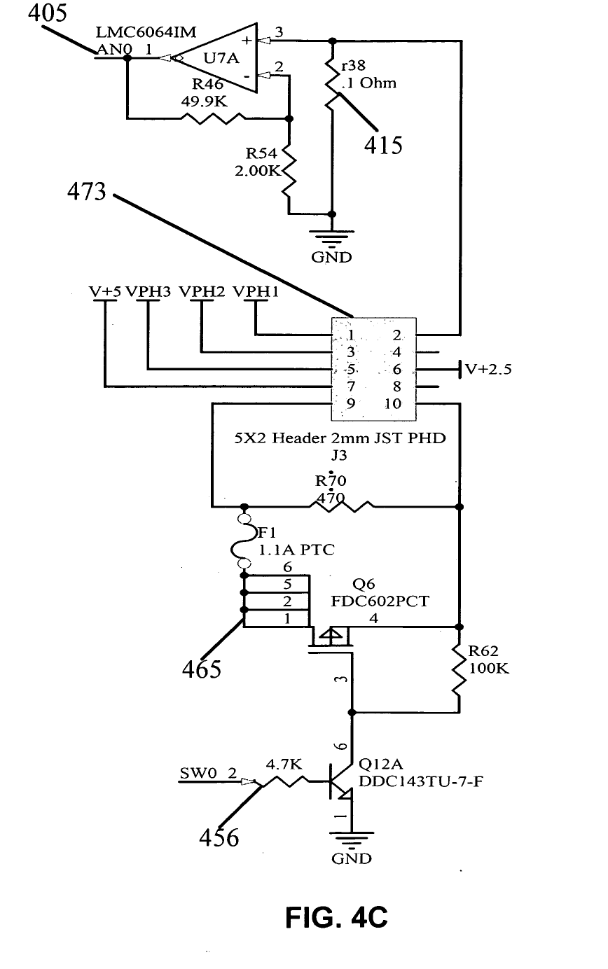

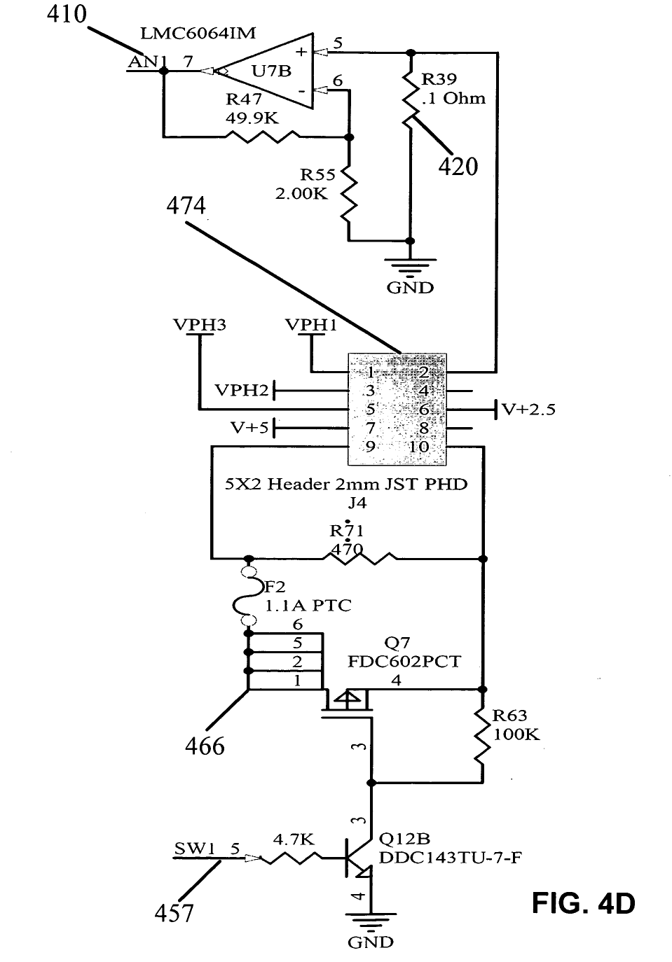

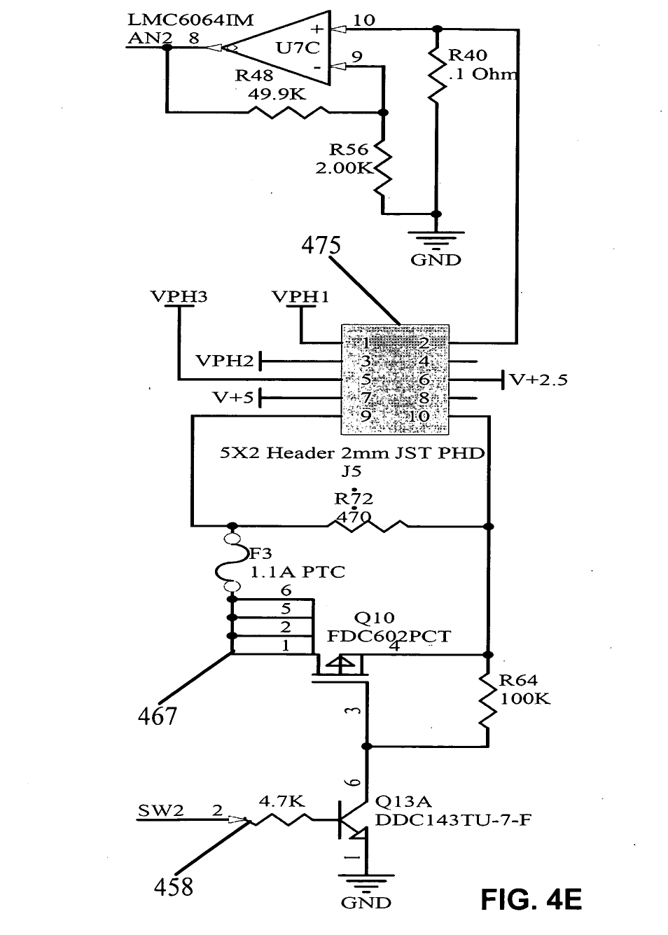

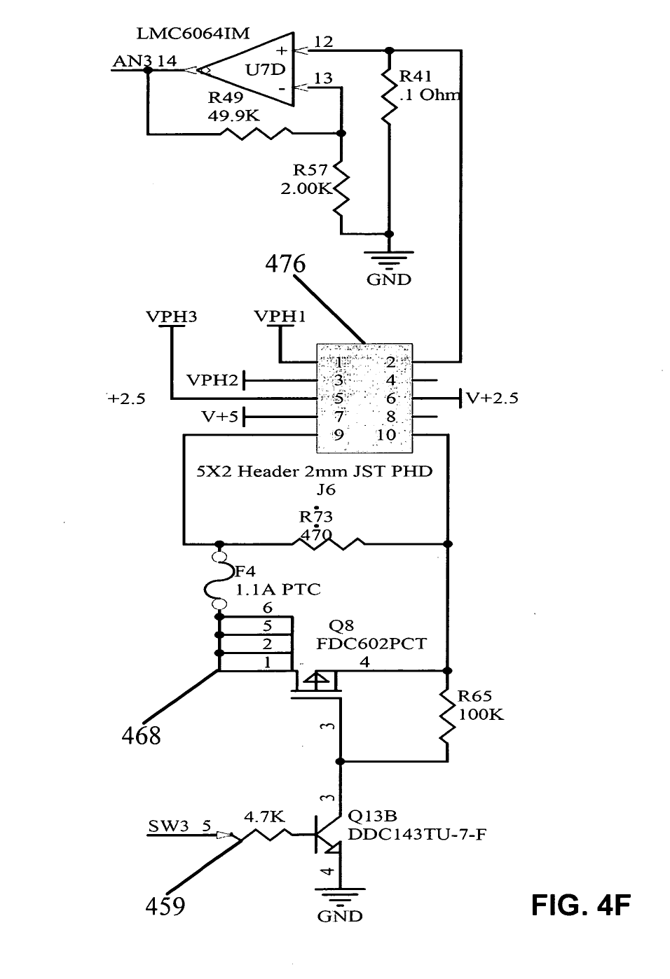

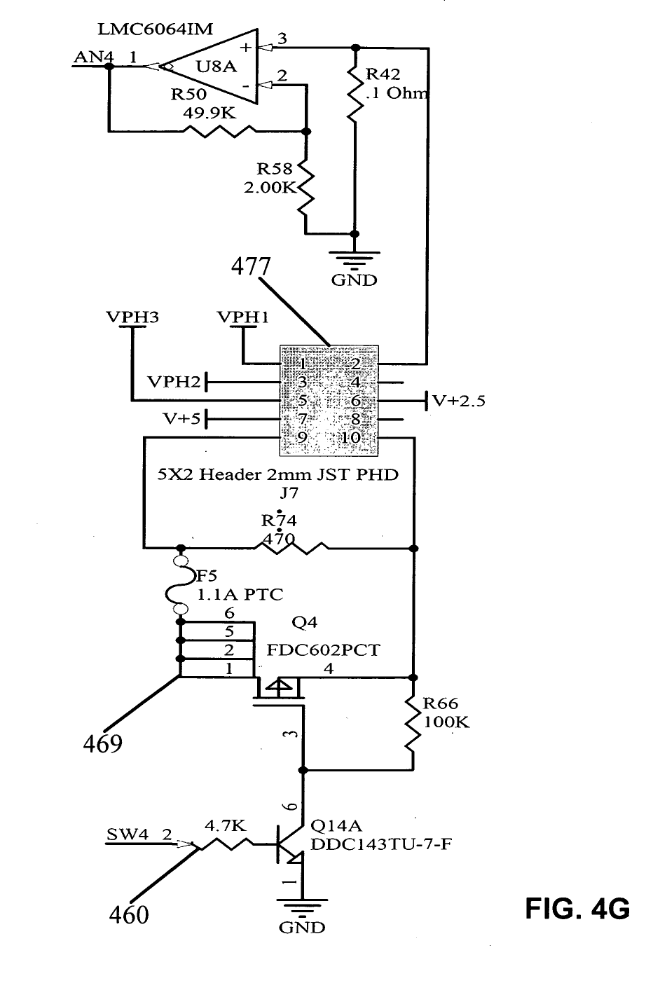

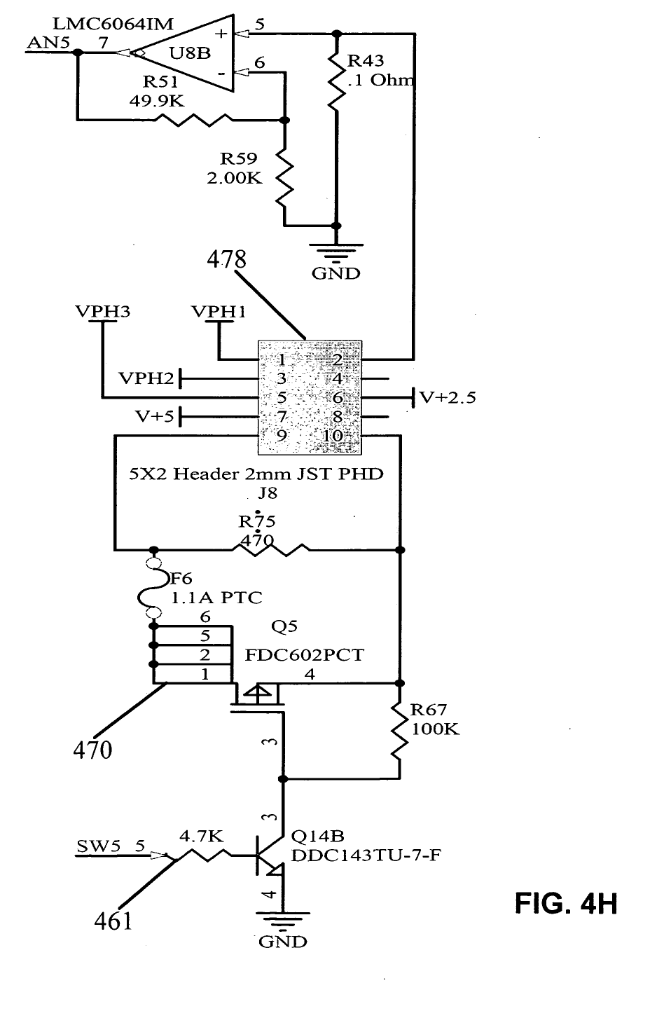

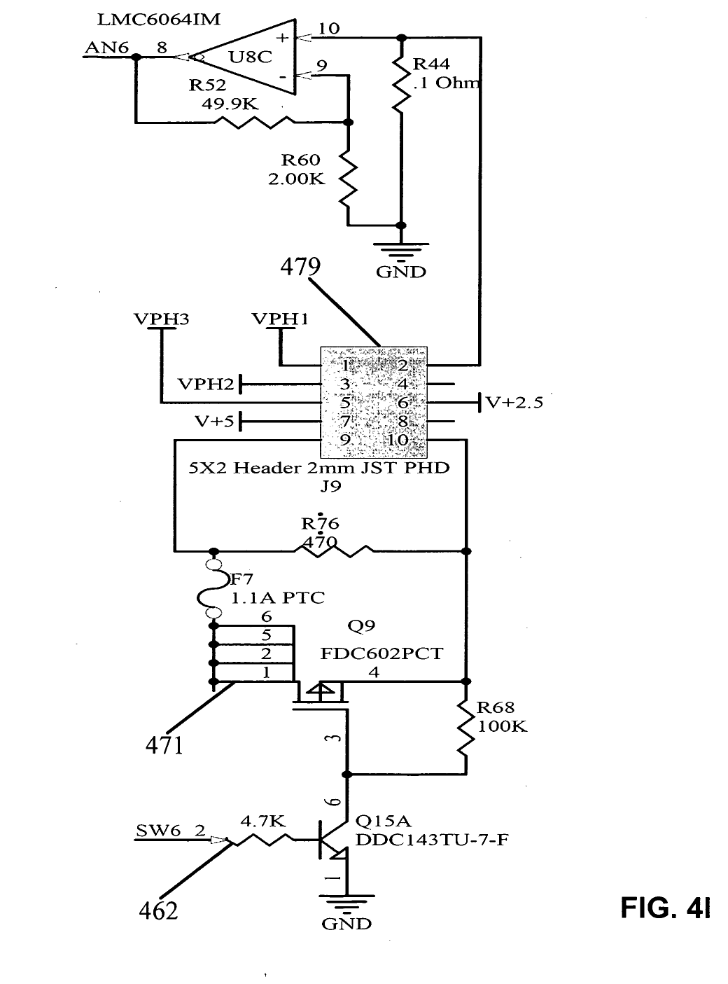

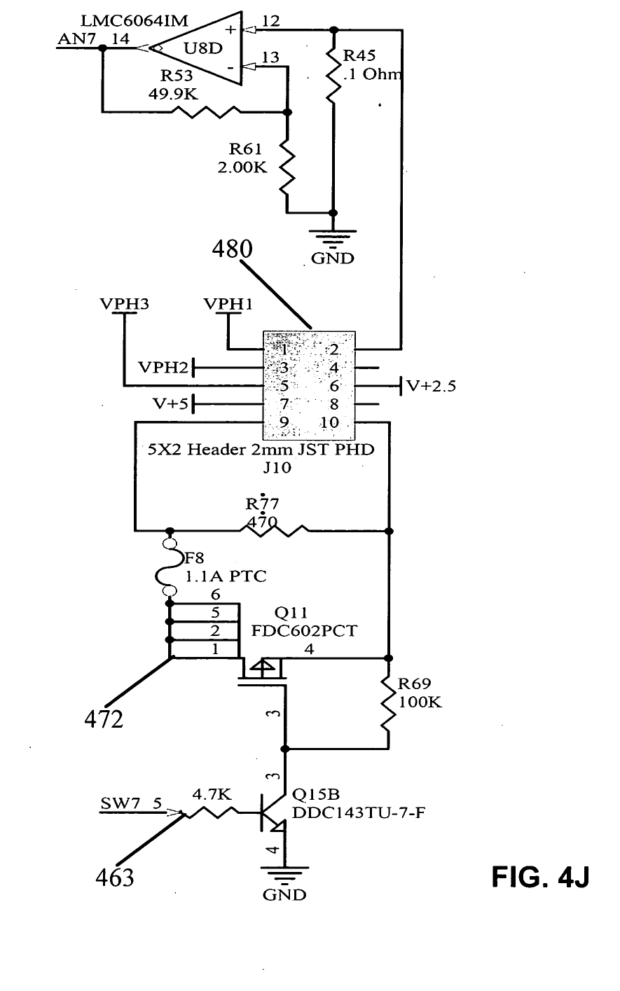

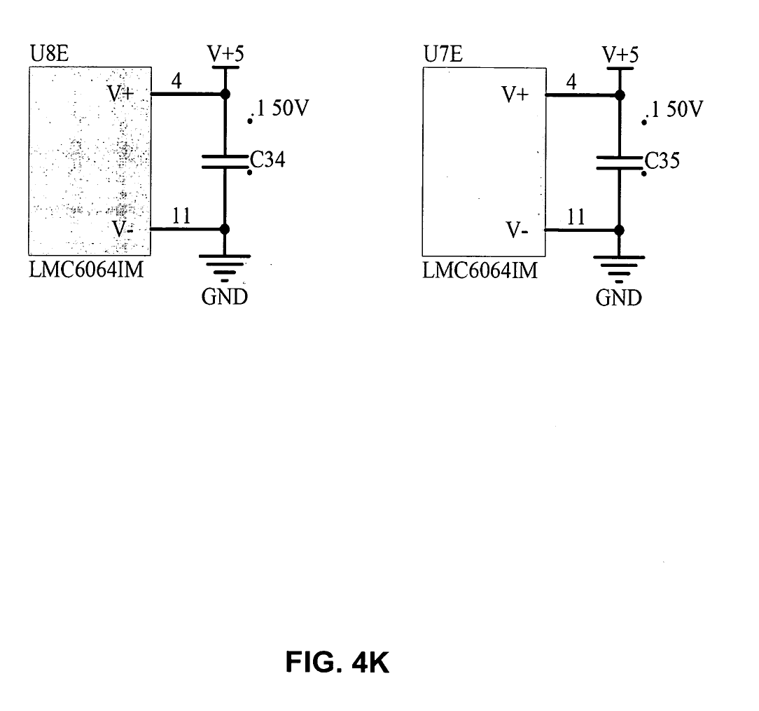

The controller board assembly 215 communicates with the power supply board assembly 225 and the display board assembly 220 through an Inter-Integrated Circuit (“I²C”) bus protocol. Particularly, a 10-pin connector 330 provides communication between the controller board assembly 215 and the power supply board assembly 225 through an I²C bus while a 4-pin connector 335 provides communication between the controller board assembly 215 and the LED display board assembly 220 through the I²C bus. In one embodiment, the connector 330 is coupled to analog input lines 345, 350, which is also coupled to the analog input lines 405, 410 (FIG. 4), which receives the sense current detected by, in one embodiment, the respective sense resistors 415, 420 (FIG. 4) on power supply board assembly 225 (FIG. 4). A plurality of rotary switches 355, 360 are connected to the microcontroller 305 to configure the system to accept multiple charge times and multiple charge rates. As one example, the rotary switch 360 may be selectively adjusted between “free” charging mode (dial at position 0) and “for Fee” charging mode (dial at positions 1 to F). Each of the rotary switches 355, 360 is a hexadecimal rotary switch having 16 input positions respectively and are associated with a look-up table stored in the microcontroller 305 to determine how much to charge (i.e., charge rate) and how long to charge (i.e., charge time). The charging times may be selectively adjusted to provide charging rates of: Free (0), 0.50 dollars, 1.00 dollar, 1.50 dollars, 2.00 dollars, 2.50 dollars, 3.00 dollars, 3.50 dollars, 4.00 dollars, 4.50 dollars, 5.00 dollars, 6.00 dollars, 7.00 dollars, 8.00 dollars, 9.00 dollars, and 10.00 dollars. The rotary switch 355 may also be selectively set to adjust the charging times between 10, 15, 20, 25, 30, 35, 40, 45, 50, 55, 65, 70, 75, 80, 85, and 90 minutes. In other non-limiting embodiments, the charging rate and charging time may be selectively changed on the controller board assembly 215 by adjusting the values stored in the look-up table for different positions of the rotary switches 355, 360. It should be appreciated that the I²C bus communicates with the peripheral assemblies, such as power supply board assembly 225 and the led display board assembly 215, through two cables, thereby eliminating the need for a multitude of wires to perform the same function.

In one non-limiting embodiment, table 1 illustrates some of the components that may be used for controller board assembly 215. The example is given solely for the purpose of illustration and is not to be construed as limitations of the present invention, as many variations are possible without departing from the spirit and scope of the invention.

TABLE 1
Exemplary components for controller board assembly

| | | Quan- | | | | | |
|---|---|---|---|---|---|---|---|
| Description | Designator | tity | [symbol] | MFG | MFG P/N | Source | Source P/N |
| 0.047 uF 50 V 10% - X7R | C1 | 1 | [symbol] | ROHM | MCH215C473KK | DigiKey | PCC1836CT |
| CAP .10 UF 50 V | C2, C6, C7, | 4 | [symbol] | KEMET | C0805C104K5RAC | DIGIKEY | 399-1170-1 |
| CERAMIC X7R 0805 | C9 | | | | | | |
| CAP CERM .47 UF | C3, C4, C5 | 3 | [symbol] | EPCOS | B37941K9474K60 | DIGIKEY | 495-1938-1-ND |
| 16 V X7R 0805 | | | | | | | |
| CAP CERAMIC 10 UF | C8 | 1 | [symbol] | PANASONIC | ECJ-3YB1E106M | DIGIKEY | PCC2326 |
| 25 V X5R 1206 | | | | | | | |
| DIODE-LED-GREEN | D1, D2 | 2 | [symbol] | LITEON | LTST-C170KGKT | Digikey | 160-1414-1 |
| CONN HEADER 6POS | J1 | 1 | [symbol] | Molex | 39-29-9062 | DigiKey | WM7326-ND |
| 4.2 MM VERT TIN | | | | Connector | | | |
| | | | | Corporation | | | |
| CONN HEADER 3 MM | J2 | 1 | [symbol] | AMP | 2-1445050-4 | Digikey | A30316-ND |
| 4POS TIN T/H | | | | | | | |
| HEADER .100 SINGL | J3 | 1 | [symbol] | SULLINS | PBC36SAAN | DIGIKEY | S1011E-36-ND |
| STR 2POS | | | | | | | |
| CONN HEADER 3 MM | J4 | 1 | [symbol] | AMP | 2-1445050-5 | Digikey | A33196-ND |
| 5POS TIN T/H | | | | | | | |
| CONN HEADER 3 MM | J5 | 1 | [symbol] | AMP | 2-1445050-3 | Digikey | A33195-ND |
| 3POS TIN T/H | | | | | | | |
| CONN HEADER 4POS | J6 | 1 | [symbol] | Molex | 90325-9004 | Digikey | WM19210-ND |
| 1.27 MM TIN T/H | | | | | | | |
| FERRITE 330 OHM | L1, L2, L17, | 5 | [symbol] | TDK | MPZ2012S331A | DIGIKEY | 445-1569-1 |
| 2.5 A 0805 | L19, L20 | | | | | | |
| FERRITE CHIP 2000 OHM | L3, L4, L5, | 15 | [symbol] | TDK | MMZ2012Y202B | DIGIKEY | 445-1561-1-ND |
| 400 MA 0805 | L6, L7, L8, | | | | | | |
| | L9, L10, L11, | | | | | | |
| | L12, L13, L14, | | | | | | |
| | L15, L16, L18 | | | | | | |
| TVS ZENER UNIDIRECT | MOV1 | 1 | [symbol] | DIODES INC | SMAJ15A-13-F | DIGIKEY | SMAJ15A-FDICT-ND |
| 400 W 15 V SMA | | | | | | | |
| TVS UNIDIRECT 6 V | MOV2 | 1 | [symbol] | DIODES INC | SMAJ6.0A-13 | DIGIKEY | SMAJ6.0A-FDICT-ND |
| 400 W SMA | | | | | | | |
| Connector, Header, | P1 | 1 | [symbol] | Sullins | Make From | Digi-Key | Make From |
| Male, 2 × 3 | | | | | PEC36DAAN | | S2012E-36-ND |
| CONN HEADER 10POS | P2 | 1 | [symbol] | Molex | B7831-1020 | DigiKey | WM1B560-ND |
| 2 MM VERT GOLD | | | | | | | |
| Connector, Header, | P3 | 1 | [symbol] | Sullins | Make From | DigiKey | Make From |
| Male, 2 × 5 JTAG | | | | Connector | PBC25DAAN | | S2011E-25-ND |
| | | | | Solutions | | | |
| TRANS-PNP-SMT 40 V | Q1 | 1 | [symbol] | MOTOROLA | MMBT3906LT1 | DigiKey | MMBT3906FS |
| RES 10K OHM ⅛ W | R1, R2, R3 | 3 | [symbol] | YAGEO | RC0505JR-0710KL | DigiKey | 311-10KARCT-ND |
| 5% 0505 SMD | | | | | | | |
| RES 180 OHM ⅛ W | R4, R7 | 2 | [symbol] | Yageo | RC0505JR-07160RL | DigiKey | 311-160ARCT-ND |
| 5% 0805 SMD | | | | | | | |
| RES 1.5K OHM ⅛ W | R5, R6 | 2 | [symbol] | Yageo | RC0505JR-071K5L | DIGIKEY | 311-1.5KARCT-ND |
| 5% 0805 SMD | | | | | | | |
| 8 PIN RES PACK 10K | RP1, RP2 | 2 | [symbol] | PANASOINC | EXB-38V103JV | DIGIKEY | Y9103CT |
| SWITCH ROTARY 16POS | S1, S2 | 2 | [symbol] | C&K | RTE1600N44 | DigiKey | 401-1878-5-ND |
| HEX SHAFT | | | | Components | | | |
| IC RS232 3 V-6.5 V | U1 | 1 | [symbol] | Texas | MAX3232ECPWR | DigiKey | 296-19263-1-ND |
| DRVR 16-TSSOP | | | | Instruments | | | |
| MCU AVR 16 KB FLASH | U2 | 1 | [symbol] | Atmel | ATMEGA164PA-AU | Digikey | ATMEGA164PA-AU-ND |
| 20 MHZ 44TQFP | | | | | | | |

[symbol]

indicates data missing or illegible when filed

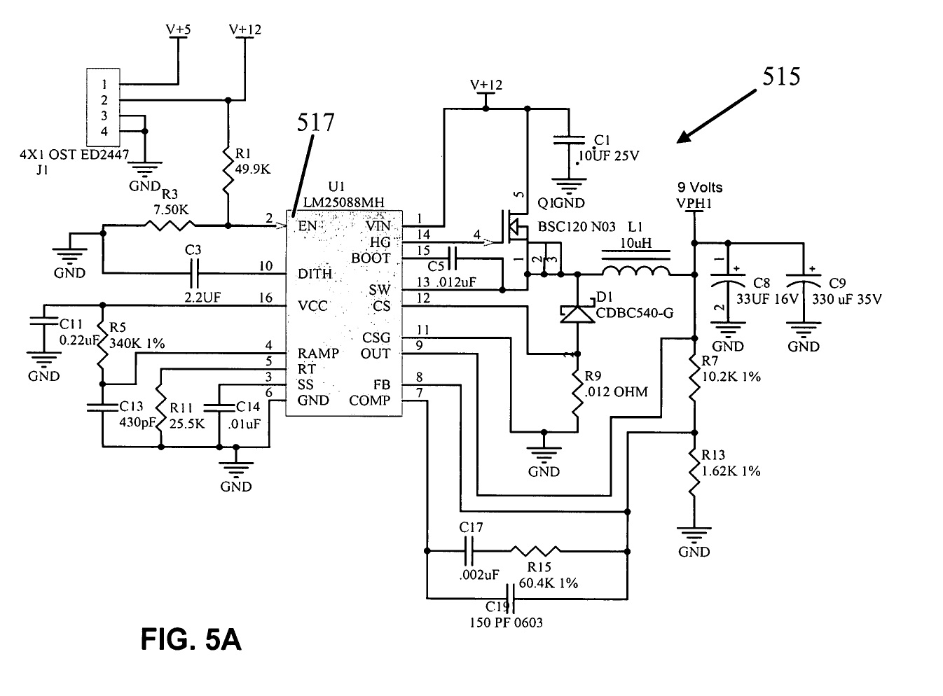

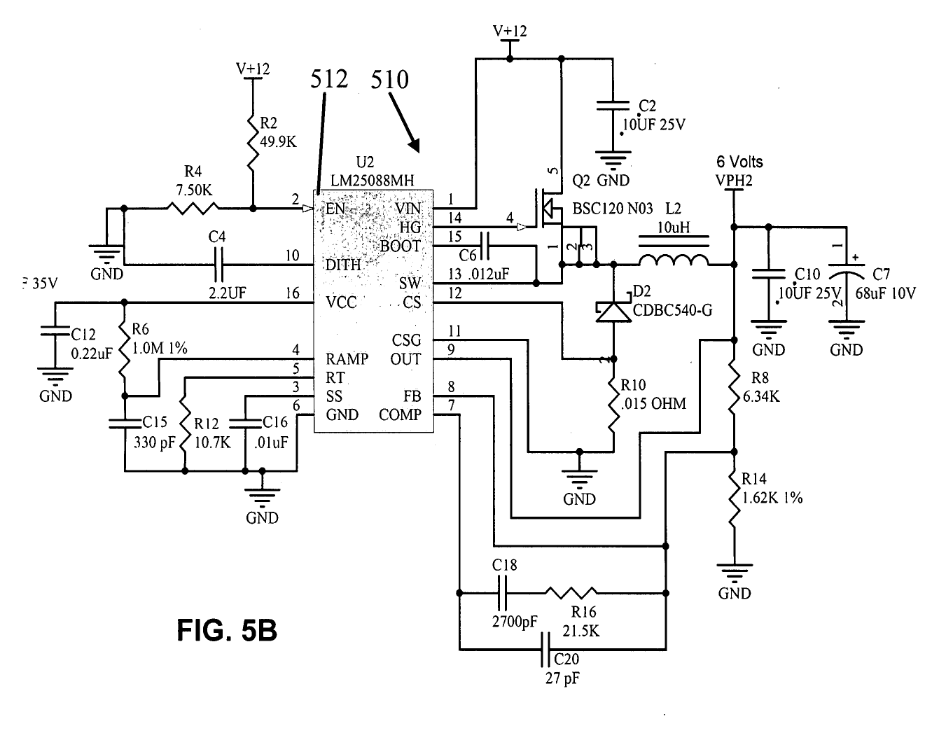

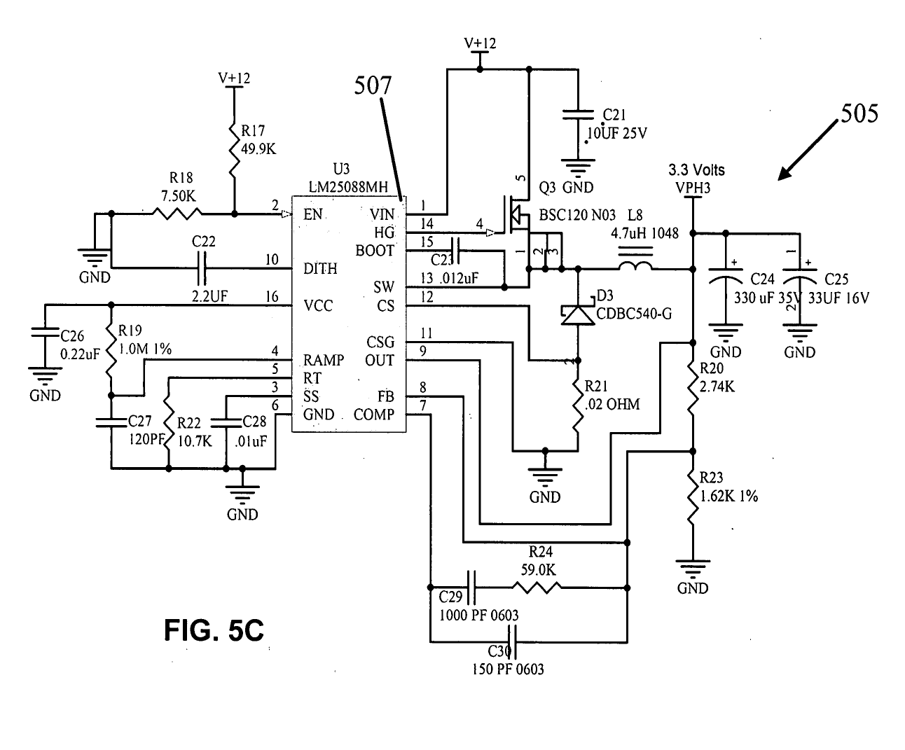

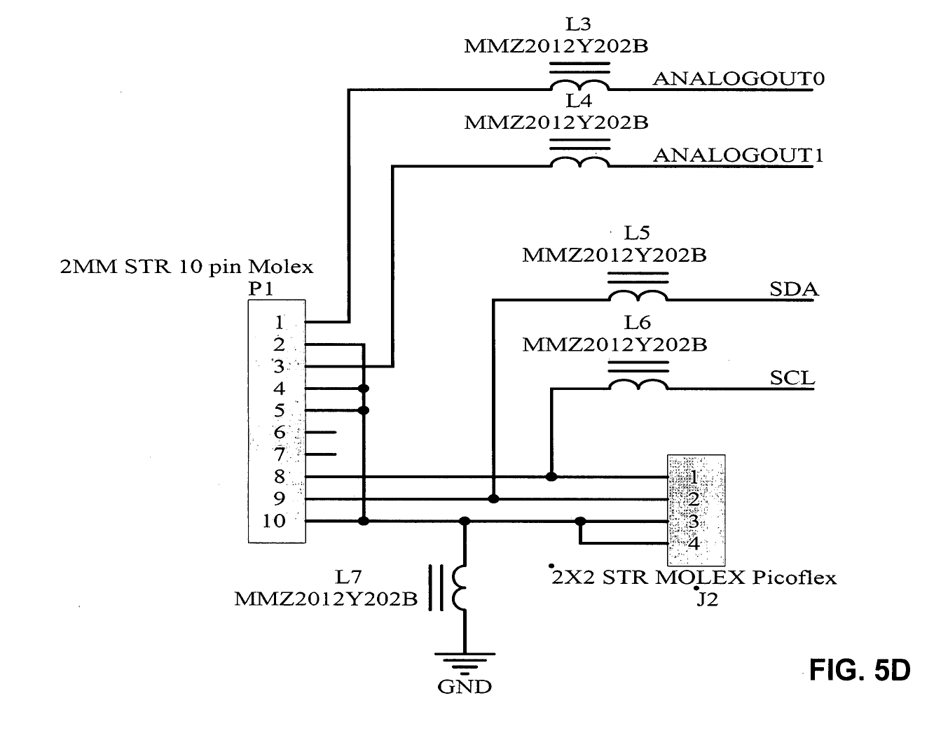

Referring now to FIGS. 4 and 5, there is illustrated a circuit diagram for power supply board assembly 225 according to a preferred embodiment of the invention. Particularly, as shown in FIG. 4, power supply board assembly 225 includes 8-channel multiplexers 450, 452 coupled to a 16-bit programmable I²C-bus device 454, which communicates sensing currents to the microcontroller 305 (FIG. 3) received from any one of the sense resistors 415-445 connected to connector ports 473-480 as well as receiving control data from microcontroller 305 to selectively turn ON (or energize), in one embodiment, the eight individual connector ports 473-480. The power supply board assembly 225 includes standard p-channel mosfet switches 465-472 to is turn ON the connector ports 473-480, which are controlled by controller 305 via the npn transistor switches 456-463. In operation, the power supply board assembly 225 having, in one embodiment, 8 independent channels senses up to 8 devices through sense currents received from sense resistors 415-445 and selectively switches the charging voltage ON or OFF through one of the four common voltage sources. The power supply board 225 is designed so that any one of the common voltage sources may supply the required charging voltage and maximum current to a particular channel that is connected to the portable device upon detection of a portable device at the connected channel. The power supply board 225 delivers enough current and voltage to a particular charging cable based on the manufacturer of the cable in order to charge the portable device that is connected to the cable It should also be appreciated that the power supply board may also deliver maximum charging currents to multiple cables simultaneously for any type of cable that is attached to the power supply board assembly 225.

Also shown in FIG. 5, power supply board assembly 225 includes a plurality of power supplies to provide the switching voltages discussed above. Particularly, the controller board assembly 215 (FIG. 3), in one non-limiting embodiment, controls three switching power supply circuits 505, 510, and 515 in addition to controlling the 5 volt power supply module 210 (FIG. 2), and these are configured to selectively supply voltages between 2.5 Volts and 15 Volts in order to selectively provide voltages to any of the communication channels. In addition, the power supply circuits 505, 510, and 515 each have a respective buck controller device 507, 512, and 517 to selectively generate the respective voltages. The power supply circuits work independently of each other and supply the appropriate voltages and maximum currents to one or more portable devices connected to the communication channels. It should be appreciated that the power supply board assembly 225 may accept any phone-specific charging cable, and delivers enough current to that charging cable to charge any type of device connected to the device. It should also be appreciated that the power supply board may also deliver maximum charging currents to multiple cables simultaneously for any type of cable that is attached to the power supply board assembly 225.

Referring now to FIG. 6, there is shown a schematic for LED board assembly 220 including a plurality of LED's configured to display status information according to an embodiment of the invention. Particularly, LED board assembly 220 includes eight green LED's 605-640 and eight red LED's 645-680 connected to 685 to communicate status information and charging conditions to the user. The LED board assembly 220 provides this information to the controller board assembly 215 via an I²C bus accessed through a 4-pin connector 690. As the charging board assembly 200 (FIG. 2) is modular, an LED display board assembly 220 is provided for each power supply board is assembly 225 in order to communicate the activity of the eight communication channels. Additional display board assemblies similar to LED display board assembly 220 may be provided to accommodate additional power supply board assembly 225. The microcontroller 305 reads and writes data to the LED display board assembly 220 through the I²C bus. In operation, a user would connect his portable device to the charging board assembly 200 when in need of a charge. As the controller board assembly 215 continually scans the sense resistors to detect the presence of a load, the portable device will be detected. Upon detection by the controller board assembly 215, the green LED's 605-640 corresponding to the device cable attached to any of the connector ports 473-480 (FIG. 4) will turn OFF and corresponding red LED's 645-680 will turn ON. The controller board assembly 215 will transmit an initialization command to microcontroller 305, and subsequently a sales command to the microcontroller 305. The microcontroller 305 will receive information regarding the transaction amount if the station 100 is set for the “for fee” mode. The amount of the transaction will be selected by the user. After negotiation information is provided by the display, such as, for example, information regarding depositing money and selecting the duration for charging the portable device, charging board assembly 200 will turn the red LED's 645-680 OFF and turn the green LED's 605-640 for that channel ON. If the charging station 100 is in the free dispense mode, charging will commence when the user connects his cell phone, However, if the charging station 100 is in the “for fee” mode, the user will be prompted to pay via credit card, paper money, or a coin acceptor unit with a negotiation message being displayed on display 110. The green LED's 605-640 will stay ON until the end of the charge cycle.

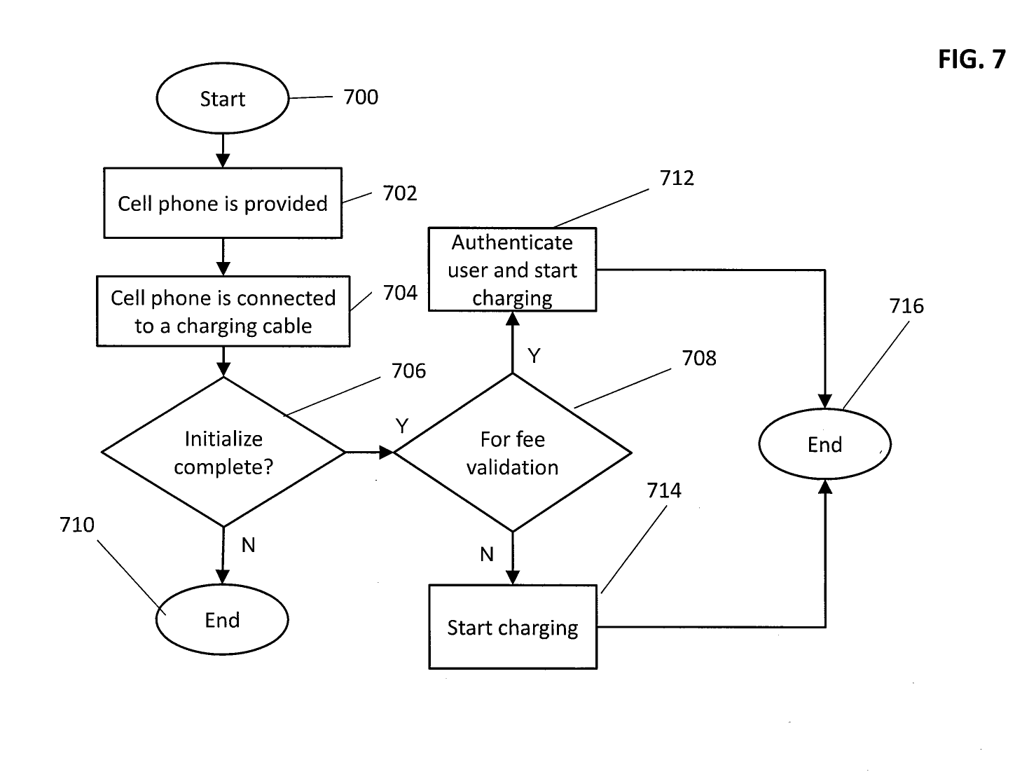

As shown in FIGS. 1 and 7, a method of utilizing charging assembly 200 located in charging station 100 for providing a charge to a portable device, for example a cell phone, is shown. As shown, the method starts in step 700 and proceeds to step 702, whereby a cell phone requiring a charge is connected to charging assembly 200 via a charging cable. The charging cable is specifically provided to receive the cell phone. The cell phone to be charged is connected to a charging connector 105 in step 704. Each connector represents a communication channel connected to a sense resistor. The charging assembly 200 continuously scans for telephones via the sense resistors and determines if a cell phone is connected. To do this, the assembly 200 turns one communication channel ON at a time until it determines that a cell phone is connected to the assembly 200. Next, the connection activates an initialization routine in step 706. If the station 100 passes the initialization step, the user is requested to enter fee payment and verification proceeds to a “for fee” validation step 708. However, if the initialization step is not complete, the process ends in step 710 and an error message is displayed. Next in step 712, the method of payment is authenticated, and the station enters the charging mode in step 712. Once the charge is complete, the process ends in step 716. Alternatively, if the station 100 is in a free charge mode, charging proceeds to step 714 when the cell phone is connected to the charging connector 105. The method ends in step 716.

It should be understood that this invention is not limited to the disclosed features and other similar method and system may be utilized without departing from the spirit and the scope of the invention. While the invention has been described with reference to the preferred embodiment and alternative embodiments, which embodiments have is been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

1. A multi-device charging assembly for providing electrical power, comprising:
a power control assembly configured for supplying a plurality of charging voltages to at least one electronic device;
a display board assembly configured for displaying status information to a user associated with said at least one electronic device; and
a microcontroller board assembly configured for controlling each of said power control assembly and said display board assembly;
wherein said microcontroller board assembly determines whether at least one charging port is connected to said at least one electronic device,
wherein said microcontroller board assembly determines whether payment is received from said user for supplying a charging voltage to said at least one electronic device, and
wherein said microcontroller board assembly transmits information to said power control assembly for supplying said charging voltage to said at least one charging port upon receiving said payment.

2. The charging assembly of claim 1, wherein said power control assembly includes a charging cable coupled to said at least one charging port.

3. The charging assembly of claim 2, wherein said at least one charging port is associated with at least one said charging voltage predetermined by said microcontroller board assembly.

4. The charging assembly of claim 1, wherein said power control assembly includes at least three power supply circuits for supplying said plurality of charging voltages.

5. The charging assembly of claim 4, wherein said at least three power supply circuits are switched to supply said plurality of charging voltages in the range of about 2.7 volts to about 15 volts.

6. The charging assembly of claim 1, further comprising an internal power supply assembly configured for providing system power and a charging voltage to said at least one charging port.

7. The charging assembly of claim 6, wherein said internal power supply is configured for converting alternating current electrical power to a five volt direct current electrical power.

8. The charging assembly of claim 1, further comprising a sense resistor coupled to said at least one charging port for detecting a presence of said at least one electronic device.

9. The charging assembly of claim 1, wherein said microcontroller board assembly includes a first rotary switch and a second rotary switch, wherein a position in said first rotary switch is associated with first information regarding a predetermined unit cost and a position is said second rotary switch is associated with second information regarding a charging rate.

10. The charging assembly of claim 2, wherein said first information and said second information is stored in a microcontroller coupled to said microcontroller board assembly.

11. The charging assembly of claim 2, wherein said microcontroller board assembly includes a plurality of interface connectors configured for coupling payment devices to said charging assembly.

12. The charging assembly of claim 11, wherein a fee for providing said charging voltage is received via at least one of said payment devices.

13. The charging assembly of claim 10, wherein said at least one charging port is associated with a communication channel of said microcontroller.

14. The charging assembly of claim 12, wherein said controller board assembly is configured for deactivating said at least one charging port when said fee cannot be processed by said controller board assembly.

15. The charging assembly of claim 1, wherein said display board assembly includes a plurality of light emitting diodes for providing said status information to said user.

16. A method for delivering a charging voltage to a plurality of charging ports, comprising the steps of:
providing a charging assembly, said charging assembly including a plurality of charging ports;
connecting at least portable device to a charging port;
scanning the plurality of charging ports to determine whether the at least one portable device is connected to the charging port;
initializing said at least one charging port upon detecting the at least one portable device;
displaying first information regarding requesting a first payment for providing charging voltage to the charging port;
processing second information regarding a second payment that is received a user associated with the at least one portable device; and
determining a duration for supplying the charging voltage to the charging port.

17. The method of claim 16, wherein the charging assembly includes:
a power control assembly configured for supplying a plurality of charging voltages;
a display board assembly configured for displaying status information; and
a microcontroller board assembly configured for controlling each of the power control assembly and the display board assembly.

18. The method of claim 17, further comprising transmitting control information to the power control assembly for controlling the charging voltage to the at least one charging port upon receiving the second payment.

19. The method of claim 17, wherein the power control assembly includes a charging cable coupled to the charging port.

20. The method of claim 17, wherein the charging port is associated with at least one of the charging voltages predetermined by the microcontroller board assembly.

21. The method of claim 17, wherein the power control assembly includes at least three power supply circuits for supplying the plurality of charging voltages.

22. The method of claim 21, wherein the at least three power supply circuits are switched to supply the plurality of charging voltages in the range of about 2.7 volts to about 15 volts.

23. The method of claim 16, further comprising the step of providing system power and a charging voltage via an internal power supply assembly to the charging port.

24. The method of claim 23, wherein the internal power supply is configured for converting alternating current electrical power to a five volt direct current electrical power.

25. The method of claim 17, further comprising the step of detecting a presence of the at least one electronic device further comprising a sense resistor coupled to said at least one charging port for.

26. The method of claim 17, further comprising the step of providing status information to the user via a plurality of light emitting diodes.

27. A multi-device charging assembly for providing electrical power, comprising:
a power control assembly configured for supplying a plurality of charging voltages to at least one electronic device;
a display board assembly configured for displaying status information to a user associated with said at least one electronic device; and
a microcontroller board assembly configured for controlling each of said power control assembly and said display board assembly.

28. The charging assembly of claim 27, wherein said microcontroller board assembly determines whether at least one charging port is connected to said at least one electronic device.

29. The charging assembly of claim 28, wherein said microcontroller board assembly determines whether payment is received from said user for supplying a charging voltage to said at least one electronic device.

30. The charging assembly of claim 29, wherein said microcontroller board assembly transmits information to said power control assembly for supplying said charging voltage to said at least one charging port upon receiving said payment.

31. The charging assembly of claim 28, wherein said power control assembly includes a charging cable coupled to said at least one charging port.

33. The charging assembly of claim 28, wherein said at least one charging port is associated with at least one said charging voltage predetermined by said microcontroller board assembly.

34. The charging assembly of claim 28, wherein said power control assembly includes at least three power supply circuits for supplying said plurality of charging voltages.

35. The charging assembly of claim 34, wherein said at least three power supply circuits are switched to supply said plurality of charging voltages in the range of about 2.7 volts to about 15 volts.

36. The charging assembly of claim 28, further comprising an internal power supply assembly configured for providing system power and a charging voltage to said at least one charging port.

37. The charging assembly of claim 36, wherein said internal power supply is configured for converting alternating current electrical power to a five volt direct current electrical power.

38. The charging assembly of claim 28, further comprising a sense resistor coupled to said at least one charging port for detecting a presence of said at least one electronic device.

39. The charging assembly of claim 28, wherein said microcontroller board assembly includes a first rotary switch and a second rotary switch, wherein a position in said first rotary switch is associated with first information regarding a predetermined unit cost and a position is said second rotary switch is associated with second information regarding a charging rate.

40. The charging assembly of claim 28, wherein said microcontroller board assembly includes a plurality of interface connectors configured for coupling payment devices to said charging assembly.
